(19) United States
(12) Patent Application Publication
(10) Pub. No.: US 2023/0136322 A1
(43) Pub. Date: May 4, 2023

(54) CUTTING DEVICE

(71) Applicants: Panasonic Holdings Corporation, Osaka (JP); TOYOTA JIDOSHA KABUSHIKI KAISHA, Aichi-ken (JP)

(72) Inventors: Yasushi TANIGUCHI, Osaka (JP); Tatsuya KAWASAKI, Nara (JP); Noriyuki MARUYAMA, Toyota-shi, Aichi-ken (JP); Noriaki YAMAMOTO, Toyota-shi, Aichi-ken (JP); Takahiro KUHARA, Toyota-shi, Aichi-ken (JP)

(21) Appl. No.: 17/912,206

(22) PCT Filed: Mar. 12, 2021
(86) PCT No.: PCT/JP2021/010004

§ 371 Date: Sep. 16, 2022

(30) Foreign Application Priority Data
Mar. 17, 2020 (JP) 2020-046171

(51) Int. Cl. B26D 7/18; B26D 1/60; H01M 10/04

(52) U.S. Cl. CPC B26D 7/18; B26D 1/60; H01M 10/0404

(57) ABSTRACT

A cutting device includes: a cutting blade that advances toward and recedes from a continuous body of electrode plates or separators so as to cut the continuous body; and a cleaning member that advances and recedes together with the cutting blade and comes into contact with a cutting section of the continuous body and cleans the cutting section.

### CROSS-REFERENCE TO RELATED APPLICATIONS

This application is the U.S. National Phase under 35 U.S.C. § 371 of International Patent Application No. PCT/JP2021/010004, filed on Mar. 12, 2021, which in turn claims the benefit of Japanese Patent Application No. 2020-046171, filed on Mar. 17, 2020, the entire content of each of which is incorporated herein by reference.

### BACKGROUND

### Field of the Invention

The present disclosure relates to a cutting device.

### Description of the Related Art

As in-vehicle batteries, for example, laminate-type batteries have been developed. Such a battery has a structure in which a container contains a laminated electrode assembly, in which multiple positive electrode plates and multiple negative electrode plates are alternatively laminated with a separator in between, and an electrolyte. The formation of the laminated electrode assembly may involve the work of cutting a continuous electrode plate into pieces and the work of cutting a continuous separator into pieces. When an electrode plate or a separator is cut, foreign matters such as dust is generated. If these foreign matters adhere to the electrode plate, a short circuit or the like may be caused, which may lead to deterioration of the quality of the laminated electrode assembly. Regarding this, Patent Literature 1 discloses a foreign material removal device that brings, after cutting a long electrode material to a predetermined length, an adhesive roll to come into contact with a cut surface of the electrode material so as to thereby remove a foreign material from the cut surface.
Patent Literature 1: Japanese Unexamined Patent Application Publication No. 2016-4738

In the conventional foreign material removal device described above, foreign materials can be removed by bringing an adhesive roll into contact with a cut surface of an electrode material, and the removed foreign materials can be attached to the adhesive roll and kept (collected). However, this foreign material removing device has a configuration in which the adhesive roll is brought into contact with the cut surface after the cut electrode material is conveyed to the downstream side. In this case, foreign materials that have fallen after the cutting and before the contact with the adhesive roll cannot be attached to the adhesive roll. Foreign materials that do not adhere to the adhesive roll may fly up onto a conveyance line and adhere to the electrode plate, which may cause deterioration in the quality of the laminated electrode assembly.

### SUMMARY OF THE INVENTION

The present disclosure has been made in view of such a situation, and a purpose thereof is to provide a technology for improving the quality of laminated electrode assemblies.

One aspect of the present disclosure relates to a cutting device. The cutting device includes: a cutting blade that advances toward and recedes from a continuous body of electrode plates or separators so as to cut the continuous body; and a cleaning member that advances and recedes together with the cutting blade and comes into contact with a cutting section of the continuous body and cleans the cutting section.

Optional combinations of the aforementioned constituting elements, and implementations of the present disclosure in the form of methods, apparatuses, and systems may also be practiced as additional modes of the present disclosure.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a schematic view of a laminated electrode assembly manufacturing device including a cutting device according to an embodiment;

FIG. 2 is a sectional view that schematically illustrates part of the cutting device;

FIG. 3 is a front view that schematically illustrates the cutting device;

FIG. 4 is a perspective view schematically illustrating a cutter holder;

FIG. 5 is a schematic view of the cutter holder viewed from a sliding direction;

FIG. 6A is a perspective view of the cutter holder in a receding position;

FIG. 6B is a schematic view of the cutter holder in a receding position when viewed from the sliding direction;

FIG. 7A is a perspective view of the cutter holder in an advancing position;

FIG. 7B is a schematic view of the cutter holder in an advancing position when viewed from the sliding direction;

FIG. 8A is a perspective view of the cutter holder according to a first exemplary variation;

FIG. 8B is a diagram schematically illustrating a first cleaning member; and

FIG. 8C is a diagram schematically illustrating a second cleaning member.

### DETAILED DESCRIPTION OF THE INVENTION

Hereinafter, the present disclosure will be described based on a preferred embodiment with reference to the figures. The embodiments do not limit the present disclosure and are shown for illustrative purposes, and not all the features described in the embodiments and combinations thereof are necessarily essential to the present disclosure. The same or equivalent constituting elements, members, and processes illustrated in each drawing shall be denoted by the same reference numerals, and duplicative explanations will be omitted appropriately.

The scales and shapes shown in the figures are defined for convenience's sake to make the explanation easy and shall not be interpreted limitatively unless otherwise specified. Terms like “first”, “second”, etc., used in the specification and claims do not indicate an order or importance by any means unless specified otherwise and are used to distinguish a certain feature from the others. Some of the components in each figure may be omitted if they are not important for explanation.

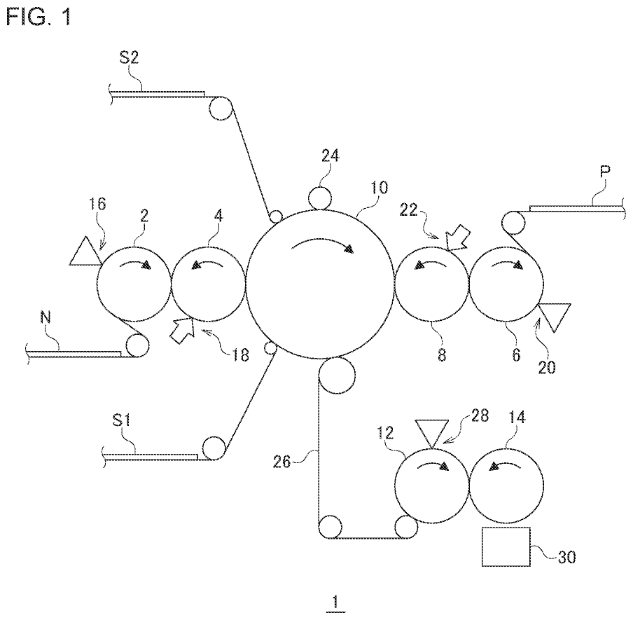

FIG. 1 is a schematic view of a laminated electrode assembly manufacturing device including a cutting device according to an embodiment. A laminated electrode assembly manufacturing device 1 is a continuous drum-type manufacturing device in which multiple drums are combined. Performing each process of cutting, heating, bonding, laminating, and the like of electrode bodies and separators on the drums enables high-speed and continuous manufacturing of laminated electrode assemblies. The laminated electrode assemblies may be used, for example, for lithium-ion secondary batteries.

The laminated electrode assembly manufacturing device 1 includes a first electrode cutting drum 2, a first electrode heating drum 4, a second electrode cutting drum 6, a second electrode heating drum 8, a bonding drum 10, a separator cutting drum 12, and a laminating drum 14.

The first electrode cutting drum 2 is a drum that cuts a continuous body of multiple first electrode plates into multiple individual first electrode plates and conveys the plates. In the present embodiment, the first electrode is a negative electrode. To the first electrode cutting drum 2, a strip-shaped first electrode continuous body N as the continuous body of multiple first electrode plates is supplied. The first electrode continuous body N includes a first electrode current collector and a first electrode active material layer. The first electrode active material layer is laminated on the first electrode current collector. In the present embodiment, the first electrode active material layer is laminated on both sides of the first electrode current collector. However, the first electrode active material layer may be laminated on only one side of the first electrode current collector.

Each of the first electrode current collector and the first electrode active material layer can be made of a publicly-known material and has a publicly-known structure. The first electrode current collector may be, for example, constituted by foil or a porous body made of copper, aluminum, or the like. The first electrode active material layer may be formed by applying, onto a surface of the first electrode current collector, first electrode mixture slurry containing a first electrode active material, a binder, a dispersant, and the like and by drying and rolling the applied film. The thickness of the first electrode current collector may be in the range from 3 μm to 50 μm inclusive, for example. Also, the thickness of the first electrode active material layer may be in the range from 10 μm to 100 μm inclusive, for example.

The first electrode cutting drum 2 includes multiple holding heads arranged in a circumferential direction of the drum, and a cutting blade that cuts the first electrode continuous body N into multiple individual first electrode plates. Each of the multiple holding heads includes a holding surface that adsorbs and holds the first electrode continuous body N. The holding surface of each holding head faces outward from the first electrode cutting drum 2. The first electrode continuous body N supplied to the first electrode cutting drum 2 is conveyed by the rotation of the first electrode cutting drum 2 while being adsorbed and held by the holding surfaces of the multiple holding heads.

Each of the multiple holding heads rotates around the central axis of the first electrode cutting drum 2 and can also move in a circumferential direction of the drum independently of other holding heads. Relative movement of each holding head is achieved by mounting thereon a motor that is different from the motor used to rotate the first electrode cutting drum 2. The independent driving of the holding heads enables adjustment of the positions of cutting by the cutting blade in the first electrode continuous body N and also enables adjustment of the positions of the individually divided first electrode plates, for example.

The first electrode cutting drum 2 adsorbs and holds the supplied first electrode continuous body N and rotates to convey the first electrode continuous body N. At a cutting position 16 schematically illustrated in FIG. 1, the first electrode cutting drum 2 cuts the first electrode continuous body N to produce the first electrode plates. The first electrode continuous body N is cut by the cutting blade at a position between adjacent holding heads, so that multiple individual first electrode plates are obtained. Each first electrode plate thus obtained is conveyed while being adsorbed and held by each holding head. The positions of the multiple produced first electrode plates are monitored by a camera or the like.

The first electrode heating drum 4 is disposed in close proximity to the first electrode cutting drum 2. Before the proximity position between the first electrode cutting drum 2 and the first electrode heating drum 4, the speed of a holding head of the first electrode cutting drum 2 is temporarily increased or decreased until it becomes substantially identical with the linear velocity of the first electrode heating drum 4. As a result, the relative speed of the holding head with respect to the first electrode heating drum 4 becomes substantially zero. At the timing when the relative speed becomes substantially zero, the holding head discharges, to the first electrode heating drum 4 side, the first electrode plate that the holding head has adsorbed and held.

The first electrode heating drum 4 rotates while adsorbing and holding the first electrode plates discharged from the first electrode cutting drum 2 and preheats the first electrode plates with a built-in heater. The preheating is performed to thermally bond a first electrode plate and a separator in the subsequent bonding process. Although the first electrode plates are heated at a heating position 18 in the present embodiment, the position is not limited thereto. For example, the first electrode plates may be heated in the entire circumferential area of the first electrode heating drum 4.

The second electrode cutting drum 6 is a drum that cuts a continuous body of multiple second electrode plates into multiple individual second electrode plates and conveys the plates. In the present embodiment, the second electrode is a positive electrode. To the second electrode cutting drum 6, a strip-shaped second electrode continuous body P as the continuous body of multiple second electrode plates is supplied. The second electrode continuous body P includes a second electrode current collector and a second electrode active material layer. The second electrode active material layer is laminated on the second electrode current collector. In the present embodiment, the second electrode active material layer is laminated on both sides of the second electrode current collector, but the second electrode active material layer may be laminated on only one side of the second electrode current collector.

Each of the second electrode current collector and the second electrode active material layer can be made of a publicly-known material and has a publicly-known structure. The second electrode current collector may be, for example, constituted by foil or a porous body made of stainless steel, aluminum, or the like. The second electrode active material layer may be formed by applying, onto a surface of the second electrode current collector, second electrode mixture slurry containing a second electrode active material, a binder, a dispersant, and the like and by drying and rolling the applied film. The thickness of the second electrode current collector may be in the range from 3 μm to 50 μm inclusive, for example. Also, the thickness of the second electrode active material layer may be in the range from 10 μm to 100 μm inclusive, for example.

The second electrode cutting drum 6 includes multiple holding heads arranged in a circumferential direction of the drum, and a cutting blade that cuts the second electrode continuous body P into multiple individual second electrode plates. Each of the multiple holding heads includes a holding surface that adsorbs and holds the second electrode continuous body P. The holding surface of each holding head faces outward from the second electrode cutting drum 6. The second electrode continuous body P supplied to the second electrode cutting drum 6 is conveyed by the rotation of the second electrode cutting drum 6 while being adsorbed and held by the holding surfaces of the multiple holding heads.

Each of the multiple holding heads rotates around the central axis of the second electrode cutting drum 6 and can also move in a circumferential direction of the drum independently of other holding heads. Relative movement of each holding head is achieved by mounting thereon a motor that is different from the motor used to rotate the second electrode cutting drum 6. The independent driving of the holding heads enables adjustment of the positions of cutting by the cutting blade in the second electrode continuous body P and also enables adjustment of the positions of the individually divided second electrode plates, for example.

The second electrode cutting drum 6 adsorbs and holds the supplied second electrode continuous body P and rotates to convey the second electrode continuous body P. At a cutting position 20 schematically illustrated in FIG. 1, the second electrode cutting drum 6 cuts the second electrode continuous body P to produce the second electrode plates. The second electrode continuous body P is cut by the cutting blade at a position between adjacent holding heads, so that multiple individual second electrode plates are obtained. Each second electrode plate thus obtained is conveyed while being adsorbed and held by each holding head. The positions of the multiple produced second electrode plates are monitored by a camera or the like.

The second electrode heating drum 8 is disposed in close proximity to the second electrode cutting drum 6. Before the proximity position between the second electrode cutting drum 6 and the second electrode heating drum 8, the speed of a holding head of the second electrode cutting drum 6 is temporarily increased or decreased until it becomes substantially identical with the linear velocity of the second electrode heating drum 8. As a result, the relative speed of the holding head with respect to the second electrode heating drum 8 becomes substantially zero. At the timing when the relative speed becomes substantially zero, the holding head discharges, to the second electrode heating drum 8 side, the second electrode plate that the holding head has adsorbed and held.

The second electrode heating drum 8 rotates while adsorbing and holding the second electrode plates discharged from the second electrode cutting drum 6 and preheats the second electrode plates with a built-in heater. The preheating is performed to thermally bond a second electrode plate and a separator in the subsequent bonding process. Although the second electrode plates are heated at a heating position 22 in the present embodiment, the position is not limited thereto. For example, the second electrode plates may be heated in the entire circumferential area of the second electrode heating drum 8.

The bonding drum 10 is a drum that forms a continuous laminated body in which unit laminated bodies, which each are constituted by a first separator, a first electrode plate, a second separator, and a second electrode plate, are continuously arranged. The bonding drum 10 is disposed in close proximity to the first electrode heating drum 4 and the second electrode heating drum 8. To the bonding drum 10, a strip-shaped first separator continuous body S1, in which multiple first separators are continuously arranged, and a strip-shaped second separator continuous body S2, in which multiple second separators are continuously arranged, are supplied. On a surface of each of the first separator continuous body S1 and the second separator continuous body S2, a thermal bonding layer is provided. The thermal bonding layer has a property of developing no adhesiveness at room temperature but developing adhesiveness when heated. The thermal bonding layer may be, for example, a thermoplastic layer containing a thermoplastic polymer, which develops adhesiveness based on plastic deformation of the thermoplastic polymer caused by heating.

Also, to the bonding drum 10, multiple first electrode plates are supplied from the first electrode cutting drum 2 via the first electrode heating drum 4, and multiple second electrode plates are supplied from the second electrode cutting drum 6 via the second electrode heating drum 8. A first electrode plate is rotationally conveyed while being preheated on the first electrode heating drum 4 and is discharged, to the bonding drum 10 side, at the proximity position between the first electrode heating drum 4 and the bonding drum 10. A second electrode plate is rotationally conveyed while being preheated on the second electrode heating drum 8 and is discharged, to the bonding drum 10 side, at the proximity position between the second electrode heating drum 8 and the bonding drum 10.

The first separator continuous body S1, each first electrode plate, the second separator continuous body S2, and each second electrode plate are supplied to the bonding drum 10 at positions provided in the enumerated order from the upstream side of the rotational direction of the bonding drum 10. Accordingly, the first separator continuous body S1 is supplied to the bonding drum 10 first at a certain position. The first separator continuous body S1 is adsorbed and held by the bonding drum 10 and rotationally conveyed. Subsequently, at a position on the downstream side of the supply position of the first separator continuous body S1, the first electrode plates are supplied from the first electrode heating drum 4 to the bonding drum 10 and placed on the first separator continuous body S1. The multiple first electrode plates are arranged on the first separator continuous body S1 at predetermined intervals in the conveying direction of the first separator continuous body S1.

Subsequently, at a position on the downstream side of the supply position of the first electrode plates, the second separator continuous body S2 is supplied to the bonding drum 10 and placed over the multiple first electrode plates. Thereafter, the first separator continuous body S1, multiple first electrode plates, and second separator continuous body S2 are pressurized by a thermocompression bonding roller 24, at a position on the downstream side of the supply position of the second separator continuous body S2. Accordingly, the first separator continuous body S1, each first electrode plate, and the second separator continuous body S2 are bonded together. Subsequently, at a position on the downstream side of the position of pressure bonding by the thermocompression bonding roller 24, the second electrode plates are supplied from the second electrode heating drum 8 to the bonding drum 10 and placed on the second separator continuous body S2. The multiple second electrode plates are arranged on the second separator continuous body S2 at predetermined intervals in the conveying direction of the second separator continuous body S2. Also, the multiple second electrode plates are bonded to the second separator continuous body S2 by the pressing force of the second electrode heating drum 8.

Through the process described above, the first separator continuous body S1, multiple first electrode plates, second separator continuous body S2, and multiple second electrode plates are laminated in this order and bonded to each other, forming a continuous laminated body 26. The continuous laminated body 26 has a structure in which the unit laminated bodies, which each are constituted by a first separator, a first electrode plate, a second separator, and a second electrode plate, are continuously connected by the first separator continuous body S1 and the second separator continuous body S2. The continuous laminated body 26 is conveyed from the bonding drum 10 to the separator cutting drum 12. By halting the supply of the second electrode plates from the second electrode cutting drum 6 side, three-layered unit laminated bodies without the second electrode plates may be produced after every fixed number of pieces. The electrode plates of which supply is halted may also be the first electrode plates.

The separator cutting drum 12 is a drum that cuts the first separator continuous body S1 and the second separator continuous body S2 in the continuous laminated body 26 to obtain multiple individual unit laminated bodies. The separator cutting drum 12 includes multiple holding heads arranged in a circumferential direction of the drum, and a cutting blade that cuts the continuous laminated body 26 into multiple individual unit laminated bodies. Each of the multiple holding heads includes a holding surface that adsorbs and holds the continuous laminated body 26. The holding surface of each holding head faces outward from the separator cutting drum 12. The continuous laminated body 26 supplied to the separator cutting drum 12 is conveyed by the rotation of the separator cutting drum 12 while being adsorbed and held by the holding surfaces of the multiple holding heads.

Each of the multiple holding heads rotates around the central axis of the separator cutting drum 12 and may also be capable of moving in a circumferential direction of the drum independently of other holding heads. Relative movement of each holding head is achieved by mounting thereon a motor that is different from the motor used to rotate the separator cutting drum 12. The independent driving of the holding heads enables adjustment of the positions of cutting by the cutting blade in the continuous laminated body 26 and also enables adjustment of the positions of the individually divided unit laminated bodies, for example.

The separator cutting drum 12 adsorbs and holds the supplied continuous laminated body 26 and rotates to convey the continuous laminated body 26. At a cutting position 28 schematically illustrated in FIG. 1, the separator cutting drum 12 cuts the continuous laminated body 26 to produce the unit laminated bodies. The continuous laminated body 26 is cut by the cutting blade at a position between adjacent holding heads, so that multiple individual unit laminated bodies are obtained. At the time, in the continuous laminated body 26, the first separator continuous body S1 and the second separator continuous body S2 are cut at a position between electrode plates that are adjacent in the conveying direction of the continuous laminated body 26. Each unit laminated body thus obtained is conveyed while being adsorbed and held by each holding head. A holding head discharges, to the laminating drum 14 side, a unit laminated body that the holding head has adsorbed and held. The positions of the multiple produced unit laminated bodies are monitored by a camera or the like.

The laminating drum 14 is a drum that laminates multiple unit laminated bodies on a lamination stage 30 to form a laminated electrode assembly. The laminating drum 14 includes multiple laminating heads arranged in a circumferential direction of the drum. Each laminating head includes a holding surface that adsorbs and holds a unit laminated body. The holding surface of each laminating head faces outward from the laminating drum 14. Each of the multiple laminating heads rotates around the central axis of the laminating drum 14 and can also move in a circumferential direction of the drum independently of other laminating heads. Relative movement of each laminating head is achieved, for example, by a cam provided on the laminating drum 14.

With the independent driving of the laminating heads, while the rotation of the laminating drum 14 can be maintained at a constant angular velocity, each laminating head can be placed in a stop state at a laminating position facing the lamination stage 30. By bringing a laminating head to be in a stop state at a position facing the lamination stage 30, the unit laminated body adsorbed and held by the laminating head can be discharged onto the lamination stage 30 with high positional accuracy.

The lamination stage 30 is disposed immediately beneath the laminating drum 14. On the lamination stage 30, the unit laminated bodies discharged from the laminating drum 14 are sequentially laminated. Thus, a laminated electrode assembly is formed. The lamination stage 30 can be driven in an X-axis direction and a Y-axis direction perpendicular to each other. Also, a tilt angle on an X-Y plane of the lamination stage 30 can be adjusted. This enables adjustment of the positions in the X-axis direction and the Y-axis direction and the tilt angle of a unit laminated body discharged from the laminating drum 14, with respect to a unit laminated body already laminated on the lamination stage 30.

At least one of the first electrode cutting drum 2, the second electrode cutting drum 6, or the separator cutting drum 12 is constituted by a cutting device 100 according to the present embodiment described below. In the following, citing the case where the first electrode cutting drum 2 is constituted by the cutting device 100 as an example, the structure of the cutting device 100 will be described.

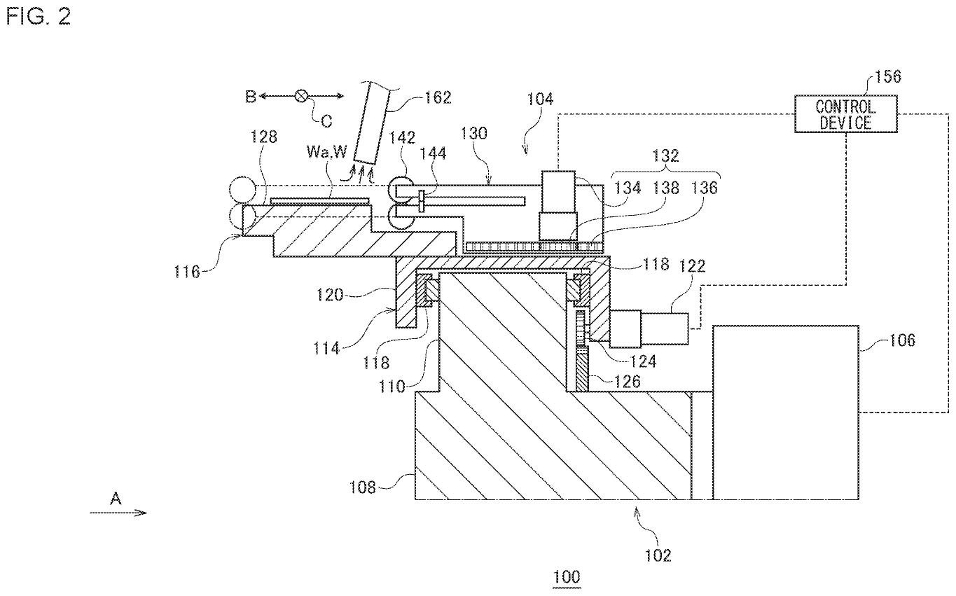

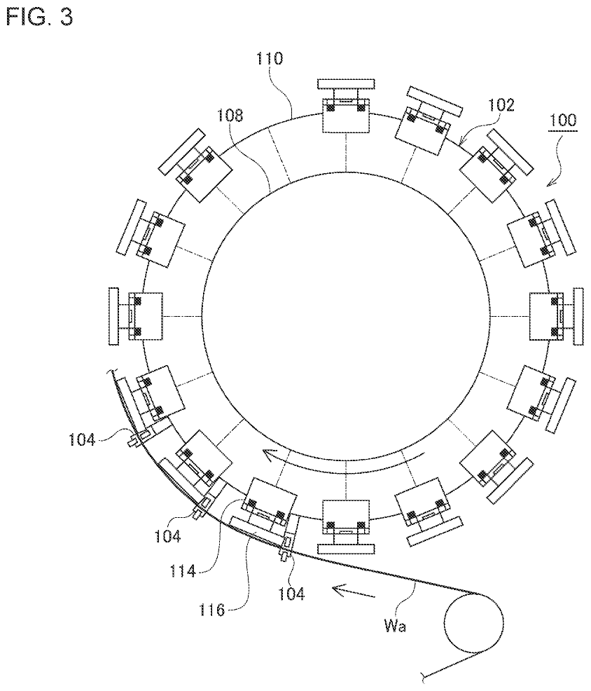

FIG. 2 is a sectional view that schematically illustrates part of a cutting device 100. FIG. 3 is a front view that schematically illustrates the cutting device 100. FIG. 2 illustrates half of a cross section of the cutting device 100. FIG. 3 illustrates the cutting device 100 observed from the direction of arrow A in FIG. 2. In FIG. 3, the illustration of each part is simplified or omitted as appropriate. Further, in the present embodiment, as an example, a cutting unit 104 is provided on a one-to-one basis for each holding head 116. However, FIG. 3 shows only some cutting units 104. Also, the interval between adjacent holding heads 116 is shown wider than the actual interval.

The cutting device 100 constituting the first electrode cutting drum 2 includes a drum section 102 and a cutting unit 104. The drum section 102 includes a drum drive unit 106, a rotating shaft 108, a disk unit 110, multiple head drive units 114, and multiple holding heads 116. The drum drive unit 106 is constituted by a publicly-known motor or the like. The rotating shaft 108 has a cylindrical shape and is connected at one end to the drum drive unit 106. The rotating shaft 108 corresponds to the central axis of the first electrode cutting drum 2. The rotating shaft 108 rotates by means of the driving of the drum drive unit 106.

The center of the disk unit 110 is connected to the other end side of the rotating shaft 108. The disk unit 110 protrudes from an outer circumferential surface of the rotating shaft 108 and extends perpendicularly to an axial direction of the rotating shaft 108. On a circumferential edge part of the disk unit 110, an arc guide 118 is provided.

The multiple head drive units 114 are arranged in a circumferential direction of the disk unit 110. Each head drive unit 114 includes a bracket 120, a motor 122, and a small gear 124. The bracket 120 has a substantial U-shape in cross section, and both sides of the substantial U-shape sandwich an edge of the disk unit 110 via the arc guide 118. The motor 122 is supported by the bracket 120. For the motor 122, a publicly-known motor may be used. The small gear 124 is connected to the rotating shaft of the motor 122 and rotates by means of the driving of the motor 122.

The small gear 124 meshes with a large gear 126 fixed to the disk unit 110 side. The large gear 126 of the present embodiment is fixed to an outer circumferential surface of the rotating shaft 108. The large gear 126 is provided over the entire circumference of the rotating shaft 108. When the motor 122 is driven, the drive torque is transmitted to the large gear 126 that meshes with the small gear 124. This allows each head drive unit 114 to move independently on the circumference of the disk unit 110 along the arc guide 118.

The multiple holding heads 116 are supported respectively by the head drive units 114. Accordingly, the multiple holding heads 116 are arranged in a circumferential direction of the disk unit 110. Each holding head 116 rotates around the rotating shaft 108 by means of the rotation of the disk unit 110 and, besides the move by means of the rotation of the disk unit 110, each holding head 116 can also move by means of a head drive unit 114.

Each holding head 116 includes a holding surface 128 that faces the protruding direction of the disk unit 110, i.e., faces outward from the circumference of the drum section 102. On the holding surface 128, an adsorption hole (not illustrated) is provided to adsorb and hold a continuous body Wa of works W, and a work W obtained individually by dividing the continuous body Wa. Since air is sucked through the adsorption hole, the continuous body Wa or a work W is adsorbed and held by the suction force.

The continuous body Wa is a cutting target of the cutting device 100 and is a constituent member of the laminated electrode assembly. More specifically, the continuous body Wa is a continuous body of electrode plates or a continuous body of separators. The continuous body of electrode plates is the above-mentioned first electrode continuous body N or the second electrode continuous body P. The continuous body of separators is the first separator continuous body S1 or the second separator continuous body S2. The continuous body of separators includes not only the first separator continuous body S1 alone or the second separator continuous body S2 alone but also the first separator continuous body S1 or the second separator continuous body S2 in the state of forming part of the continuous laminated body 26. The work W is an electrode plate, a separator, or a unit laminated body. In the case of the first electrode cutting drum 2, the continuous body Wa is the first electrode continuous body N, and the work W is the first electrode plate. The continuous body Wa is conveyed by the rotation of the disk unit 110 while being adsorbed and held by the holding surfaces 128 of the multiple holding heads 116.

The cutting unit 104 is a mechanism that cuts the continuous body Wa into multiple individual works W. In the present embodiment, a cutting unit 104 is provided on a one-to-one basis for each holding head 116. The cutting unit 104 moves together with the holding head 116 so as to cut the continuous body Wa. The cutting unit 104 does not have to be provided on a one-to-one basis for the holding head 116, and the cutting unit 104 may move independently of the holding head 116.

Each cutting unit 104 has a cutter holder 130 and a cutter drive unit 132. The cutter holder 130 is supported by a bracket 120. The cutter holder 130 can slide in a direction substantially perpendicular to the extending direction of the continuous body Wa. The cutter drive unit 132 has a motor 134, a rack rail 136, and a pinion 138.

The rack rail 136 is provided on the cutter holder 130. The rack rail 136 extends in the axial direction of the drum section 102. The motor 134 is supported by the bracket 120. For the motor 134, a publicly-known motor can be used. To the rotating shaft of the motor 134, a pinion 138 is connected. The pinion 138 is meshed with the rack rail 136. The rack rail 136 and the pinion 138 constitute a rack and pinion mechanism; when the motor 134 is driven to rotate the pinion 138, the drive torque is transmitted to the rack rail 136, which causes the cutter holder 130 to slide.

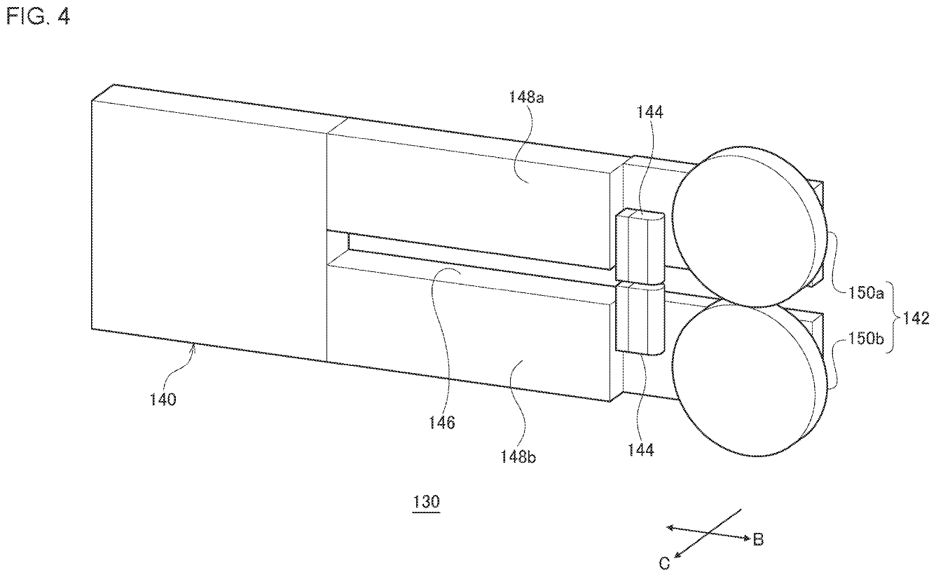

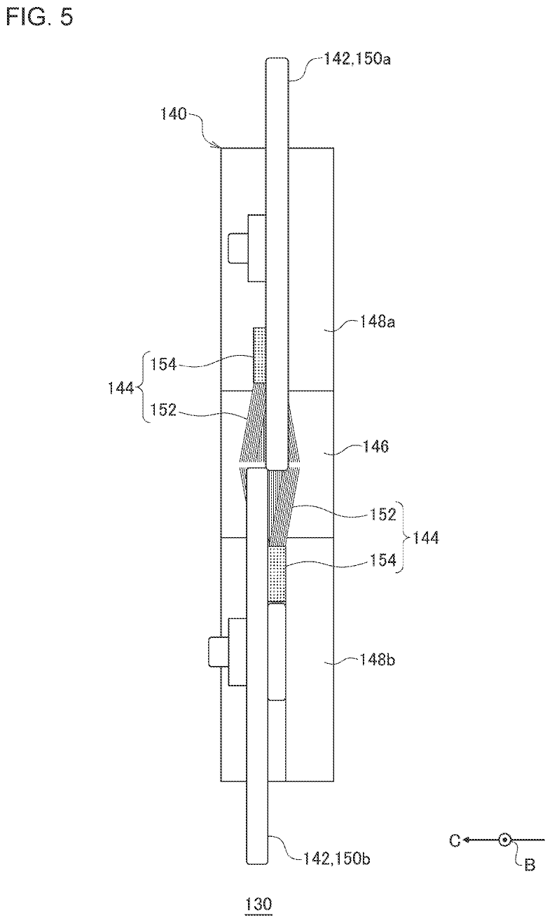

The cutter holder 130 has a holder body 140, a cutting blade 142, and a cleaning member 144. FIG. 4 is a perspective view schematically illustrating the cutter holder 130. FIG. 5 is a schematic view of the cutter holder 130 viewed from a sliding direction B.

The holder body 140 is a long plate-like body extending in the sliding direction B of the cutter holder 130. The holder body 140 is disposed such that two main surfaces facing each other face the conveyance direction C of the continuous body Wa. One end of the holder body 140 faces the holding surface 128 side while the cutter holder 130 is in a receding position described later. One end of the holder body 140 is provided with a slit 146 extending in the sliding direction B and is divided into a first arm 148a and a second arm 148b by the slit 146. The first arm 148a and the second arm 148b are aligned in the thickness direction of the continuous body Wa. The other end of the holder body 140 is provided with the rack rail 136 (see FIG. 2).

At one end of the holder body 140, cutting blades 142 is supported. The cutting blades 142 of the present embodiment are constituted by a pair of circular blades 150a and 150b. The circular blade 150a is supported at the distal end of the first arm 148a, and the circular blade 150b is supported at the distal end of the second arm 148b. The circular blades 150a and 150b are arranged in the thickness direction of the continuous body Wa.

Further, the first arm 148a and the second arm 148b each support a cleaning member 144. On the first arm 148a, the cleaning member 144 is located closer to the base end side of the first arm 148a than the circular blade 150a. In the same way, on the second arm 148b, the cleaning member 144 is located closer to the base end side of the second arm 148b than the circular blade 150b. Therefore, when the cutter holder 130 is in the receding position described later, each cleaning member 144 is located farther from the continuous body Wa than the cutting blade 142.

The cleaning members 144 of the present embodiment are brushes with multiple bristles bundled together. Each cleaning member 144 has a bristle bundle 152 and a bristle bundle holder 154. The orientation of a pair of cleaning members 144 is determined such that the respective bristle bundles 152 face each other. Each hair bundle 152 is disposed on the line of motion of a corresponding cutting blade 142.

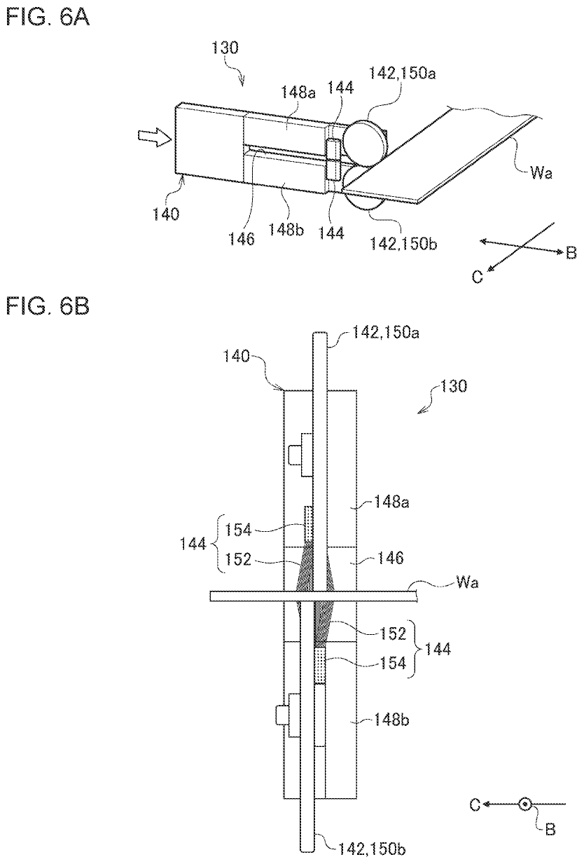

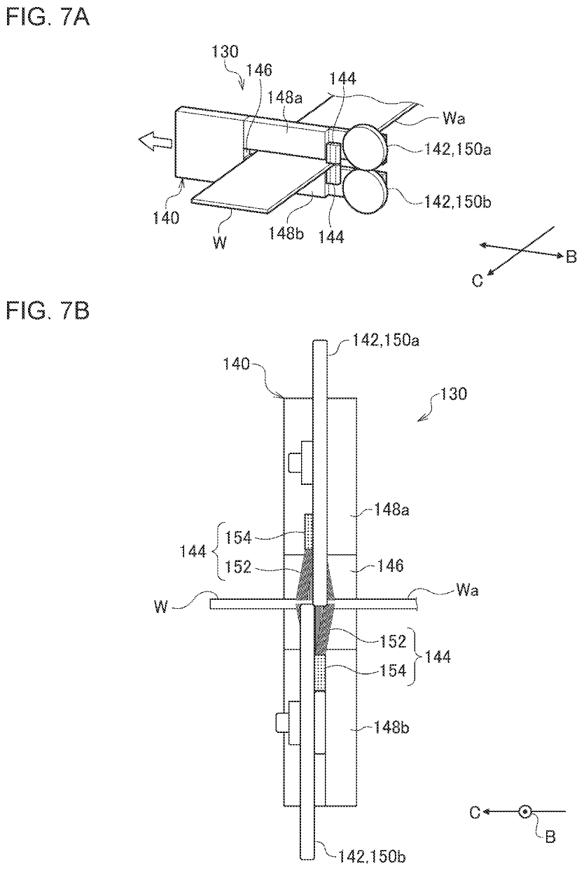

The sliding of the cutter holder 130 can allow the cutting blades 142 and the cleaning members 144 to advance toward and recede from the continuous body Wa. FIG. 6A is a perspective view of the cutter holder 130 in a receding position. FIG. 6B is a schematic view of the cutter holder 130 in a receding position when viewed from the sliding direction B. FIG. 7A is a perspective view of the cutter holder 130 in an advancing position. FIG. 7B is a schematic view of the cutter holder 130 in an advancing position when viewed from the sliding direction B. In FIG. 2, the cutter holder 130 in a receding position is illustrated with a solid line, and the cutter holder 13 in an advanced position is illustrated with a broken line.

The circular blade 150a and the circular blade 150b are displaced from each other when viewed from the sliding direction B of the cutter holder 130, in other words, the advancing or receding direction of the cutting blades 142, and the respective cutting edges of the blades overlap each other when viewed from the conveyance direction C of the continuous body Wa. Further, the positions of the circular blade 150a and the circular blade 150b with respect to a holding surface 128 are determined such that the continuous body Wa can pass between the two blades when the cutter holder 130 slides. The pair of cleaning members 144 are disposed so as to sandwich the continuous body Wa when viewed from the advancing or receding direction of the cutting blades 142. One of the cleaning members 144 is disposed such that the tip of the corresponding bristle bundle 152 is in contact with one surface of the continuous body Wa. The other cleaning member 144 is disposed such that the tip of the corresponding bristle bundle 152 is in contact with the opposite surface of the continuous body Wa.

When the cutter holder 130 slides toward an advancing position from a receding position, the cutting blades 142 advance toward the continuous body Wa, and the circular blades 150a and 150b rotate to cut the continuous body Wa. The cutting blades 142 pass between two adjacent holding heads 116 to advance toward or recede from the continuous body Wa. When the cutting blades 142 move to the advancing position, the continuous body Wa and an end of the work W enter the slit 146. This avoids interference between the holder body 140 and the continuous body Wa and interference between the holder body 140 and the work W.

The cleaning members 144 advance toward the continuous body Wa together with the cutting blades 142. The cleaning members 144 move across the continuous body Wa in the width direction following the cutting blades 142. At that time, the cleaning members 144 come into contact with the cutting section of the continuous body Wa and clean the cutting section. More specifically, the cutting section of the continuous body Wa passes between the pair of cleaning members 144 facing each other. This allows the cutting section to be brushed on both sides of the continuous body Wa.

When metal foil constituting the electrode plate or resin film constituting the separator is cut with the cutting blades 142, burrs may be produced on the cutting section. In contrast, when the pair of cleaning members 144 advance together with the cutting blades 142, the cutting section is brushed with the bristle bundles 152, brushing away the burrs. The burr pieces that have been brushed away are collected by a collection machine 162 (see FIG. 2). The collection machine 162 is composed of, for example, an air suction machine or the like.

When the holder body 140 in the advancing position goes back to the receding position, the cutting blades 142 pass through the cutting section of the continuous body Wa. The cleaning members 144 also come into contact with the cutting section of the continuous body Wa and clean the cutting section at the time of the receding. This allows burrs left after the cleaning when the holder body 140 advances to be brushed off. In addition to the cleaning of the cutting section by the cleaning members 144, the cutting device 100 may also perform cleaning by air blowing or air suction and removal of electricity from the cutting section by an ionizer.

As shown in FIG. 2, the operations of the drum drive unit 106, the head drive units 114, and the cutter drive unit 132 are controlled by the control device 156. The control device 156 may be implemented by an element such as a CPU or memory of a computer or by a circuit as a hardware configuration, and by a computer program or the like as a software configuration. FIG. 2 illustrates a functional block implemented by cooperation of such components. Therefore, it will be obvious to those skilled in the art that the functional blocks may be implemented in a variety of manners by a combination of hardware and software.

The control device 156 receives image data from a camera that images the first electrode cutting drum 2 and, based on the positions of each holding head 116 and each cutting unit 104 and the like derived from the image data, the control device 156 can control the operation of each part. The control device 156 may also acquire information from a sensor other than the camera to control the operation of each part. The control device 156 can also control the operation of each part based on a preset operation program.

Although the above description describes a case in which the first electrode cutting drum 2 is constituted by the cutting device 100, the second electrode cutting drum 6 or the separator cutting drum 12 may be constituted by the cutting device 100. When the second electrode cutting drum 6 is constituted by the cutting device 100, the continuous body Wa is the second electrode continuous body P, and the works W are the second electrode plates. Also, when the separator cutting drum 12 is constituted by the cutting device 100, the continuous body Wa is the continuous laminated body 26, and the works W are the unit laminated bodies.

As described above, the cutting device 100 according to the present embodiment includes cutting blades 142 that advance toward or recede from a continuous body Wa of electrode plates or separators so as to cut the continuous body Wa and cleaning members 144 that advance or recede along with the cutting blades 142 and come into contact with a cutting section of the continuous body Wa so as to clean the cutting section. By causing the cleaning members 144 to advance and recede together with the cutting blades 142 so as to bring the cleaning members to come into contact with the cutting section and clean the cutting section, the cutting section can be cleaned immediately after the cutting of the continuous body Wa. Therefore, foreign materials produced by cutting can be collected at an earlier stage. This can reduce miss collection of foreign matters and improve the quality of laminated electrode assemblies. Further, since the cutting process of the continuous body Wa and the cleaning process of the cut surface can be performed almost simultaneously, the throughput as well as the quality of the works W can be improved.

When the electrode plate or the separator is cut with the cutting blades 142 as described above, burrs may be produced on the cutting section. Burrs generated at the cutting section may be connected to the continuous body Wa or the works W and may not be able to be removed from the cutting section by air suction, air blowing, or the like. Burrs remaining in the cutting section may detach from the cutting section due to vibration or other causes during the conveyance of the continuous body Wa or the works W and may contaminate the conveyance line. Further, if burrs remain on the works W, the burrs may cause, for example, a short circuit in the laminated electrode assembly. In contrast, by bringing the cleaning members 144 to come into contact with the cutting section so as to clean the cutting section, more burrs generated in the cutting section can be removed and collected. This can improve the quality of laminated electrode assemblies.

Further, the cleaning members 144 according to the present embodiment are disposed so as to sandwich the continuous body Wa when viewed from the advancing or receding direction of the cutting blades 142. This allows the cutting section to be cleaned from both sides of the continuous body Wa. Therefore, the possibility of burrs remaining in the cutting section can be further reduced, and the quality of laminated electrode assemblies can be further improved.

Also, the cleaning members 144 of the present embodiment are brushes with multiple bristles bundled together. This allows for proper adjustment of the force applied to the cutting section of the continuous body Wa. Thus, it is possible to suppress damage to the works W and the continuous body Wa while peeling off burrs adhering to the cutting section. For example, if adhesive rolls are used as the cleaning members 144 when the continuous body Wa is the first electrode continuous body N or the second electrode continuous body P, the active material layer may adhere to the adhesive rolls and peel off. In contrast, by using brushes for the cleaning members 144, the active material layer can be prevented from peeling off.

Described above is a detailed explanation on the embodiments of the present disclosure. The above-described embodiments merely show specific examples for carrying out the present disclosure. The details of the embodiments do not limit the technical scope of the present disclosure, and many design modifications such as change, addition, deletion, etc., of the constituent elements may be made without departing from the spirit of the present disclosure defined in the claims. New embodiments resulting from added design change will provide the advantages of the embodiments and variations that are combined. In the above-described embodiments, the details for which such design change is possible are emphasized with the notations “according to the embodiment”, “in the embodiment”, etc. However, design change is also allowed for those without such notations. Optional combinations of the above constituting elements are also valid as embodiments of the present disclosure. Hatching applied to a cross section of a drawing does not limit the material of an object to which the hatching is applied.

### First Exemplary Variation

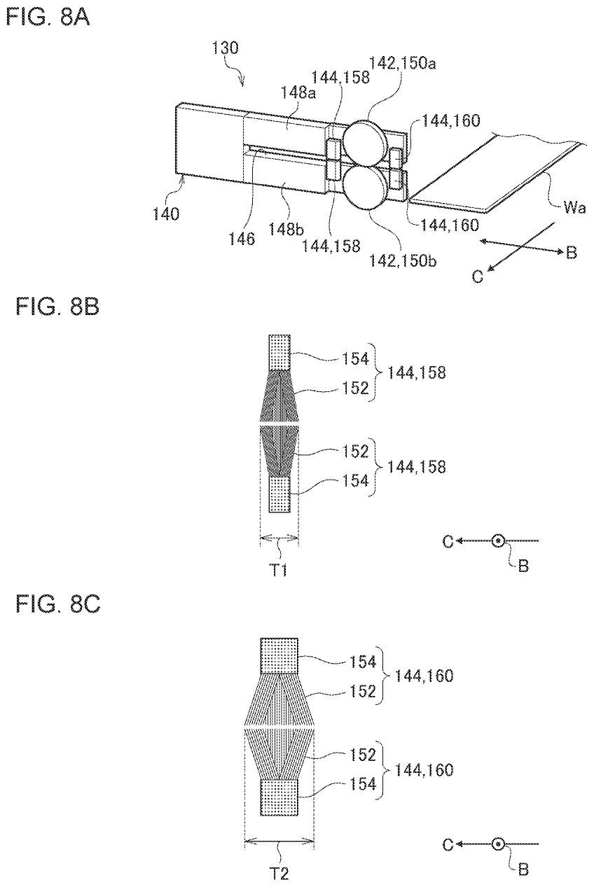

FIG. 8A is a perspective view of a cutter holder 130 according to a first exemplary variation. FIG. 8B is a diagram schematically illustrating a first cleaning member. FIG. 8C is a diagram schematically illustrating a second cleaning member. FIG. 8A illustrates the cutter holder 130 in a receding position. In the embodiment, while the cutter holder 130 is in the receding position, cleaning members 144 are provided only on the side farther from the continuous body Wa than cutting blades 142. On the other hand, in the present exemplary variation, cleaning members 144 are provided so as to sandwich cutting blades 142 in the sliding direction B of the cutter holder 130.

In other words, the cleaning members 144 according to the present exemplary variation include first cleaning members 158 that are disposed on the side farther from the continuous body Wa than the cutting blades 142 and second cleaning members 160 that are disposed on the side closer to the continuous body Wa than the cutting blades 142, when the cutting blades 142 are in a receding position from the continuous body Wa. Further, a first arm 148a and a second arm 148b each have a first cleaning member 158 and a second cleaning member 160. The orientation of a pair of first cleaning members 158 is determined such that the respective bristle bundles 152 face each other. In the same manner, the orientation of a pair of second cleaning members 160 is determined such that the respective bristle bundles 152 face each other.

By providing the first cleaning member 158 and the second cleaning member 160 so as to sandwich the cutting blades 142 in the sliding direction B of the cutter holder 130, the cut surface of the continuous body Wa can be brushed with the first cleaning member 158 and the second cleaning member 160 at the time of the receding of the cutting blades 142. This allows for collection of more foreign matters produced by cutting, and the quality of laminated electrode assemblies can be improved.

Further, rather than making the brush stiffer and reducing the number of brushings, it is better to make the brush more pliant and increase the number of brushings since more burrs can be peeled off while reducing the possibility of damage to the continuous body Wa and the works W. Therefore, according to the present exemplary variation, the quality of laminated electrode assemblies and batteries can be further improved.

Preferably, the dimension T2 of the second cleaning member 160 in an extension direction C of the continuous body Wa is larger than the dimension T1 of the first cleaning member 158 in the extension direction C of the continuous body Wa. When the continuous body Wa is cut, two sections that have been cut may be separated in the conveyance direction C of the continuous body Wa. For this reason, more burrs can be removed from the cut surface by making the dimension T2 of the second cleaning member 160, which mainly cleans the cutting section when the cutter holder 130 recedes, to be larger than the dimension T1 of the first cleaning member 158, which mainly cleans the cutting section when the cutter holder 130 advances. Further, by making the dimension T1 of the first cleaning member 158 to be smaller than the dimension T2 of the second cleaning member 160, the size of the cleaning mechanism and even the size of the cutter holder 130 can be reduced while suppressing the decrease in the efficiency of removing burrs.

The cutter holder 130 may be provided with only one of the first cleaning member 158 and the second cleaning member 160. The cutter holder 130 of the embodiment corresponds to a configuration in which the second cleaning member 160 is deleted from the cutter holder 130 of the present exemplary variation, i.e., a configuration in which only the first cleaning member 158 is provided. If only one of the first cleaning member 158 and the second cleaning member 160 is to be provided in the cutter holder 130, it is more preferable to provide the first cleaning member 158. This is because when the first cleaning member 158 is provided, the cut surface can be cleaned sooner after the cutting of the continuous body Wa compared to a case where the second cleaning member 160 is provided, and the cutter holder 130 is cleaned twice, at the time of the advancing of the cutter holder 130 and at the time of the receding of the cutter holder 130, further improving the collection efficiency of the burr pieces.

### Another Exemplary Variation

A cutting device 100 is not limited to a roll type in which the continuous body Wa is conveyed in the circumferential direction of the drum and may also be of a stage type in which the continuous body Wa is conveyed in the horizontal direction or the like, for example.

1. A cutting device comprising:
a cutting blade that advances toward and recedes from a continuous body of electrode plates or separators so as to cut the continuous body; and
a cleaning member that advances and recedes together with the cutting blade and comes into contact with a cutting section of the continuous body and cleans the cutting section.

2. The cutting device according to claim 1, wherein
the cleaning member is disposed so as to sandwich the continuous body when viewed from the advancing or receding direction of the cutting blade.

3. The cutting device according to claim 1, wherein
the cleaning members includes a first cleaning member that is disposed on the side farther from the continuous body than the cutting blade and a second cleaning member that is disposed on the side closer to the continuous body than the cutting blade, when the cutting blade is in a receding position from the continuous body.

4. The cutting device according to claim 3, wherein
the dimension of the second cleaning member in an extension direction of the continuous body is larger than the dimension of the first cleaning member in the extension direction of the continuous body.

5. The cutting device according to claim 1, wherein
the cleaning member is a brush with multiple bristles bundled together.
